(19) United States
(12) Patent Application Publication
(10) Pub. No.: US 2008/0256352 A1
(43) Pub. Date: Oct. 16, 2008

(54) Methods and systems of booting of an intelligent non-volatile memory microcontroller from various sources

(75) Inventors: David Q. Chow, San Jose, CA (US); I-Kang Yu, Palo Alto, CA (US); Abraham Chih-Kang Ma, Fremont, CA (US); Ming-Shiang Shen, Taipei Hsien (TW)

Correspondence Address: ROGER H. CHU, 19499 ERIC DRIVE, SARATOGA, CA, 95070, US

(73) Assignee: Super Talent Electronics, Inc., San Jose, CA (US)

(21) Appl. No.: 12/119,477

(22) Filed: May 12, 2008

Related U.S. Application Data
(63) Continuation-in-part of application No. 12/025,706, filed on Feb. 4, 2008.
Application No. 12/025,706 is a continuation-in-part of application No. 11/871,011, filed on Oct. 11, 2007.
Application No. 11/871,011 is a continuation-in-part of application No. 12/054,310, filed on Mar. 24, 2008.
Application No. 12/054,310 is a continuation-in-part of application No. 12/035,398, filed on Feb. 21, 2008.
Application No. 12/035,398 is a continuation-in-part of application No. 11/864,671, filed on Sep. 28, 2007.
Application No. 11/864,671 is a continuation-in-part of application No. 10/789,333, filed on Feb. 26, 2004, now Pat. No. 7,318,117.
Application No. 10/789,333 is a continuation-in-part of application No. 10/957,089, filed on Oct. 1, 2004.
Application No. 10/957,089 is a continuation-in-part of application No. 11/309,594, filed on Aug. 28, 2006, now Pat. No. 7,383,362.
Application No. 11/309,594 is a continuation-in-part of application No. 10/707,277, filed on Dec. 2, 2003, now Pat. No. 7,103,684.
Application No. 10/707,277 is a continuation-in-part of application No. 11/624,667, filed on Jan. 18, 2007.
Application No. 11/624,667 is a division of application No. 09/478,720, filed on Jan. 6, 2000, now Pat. No. 7,257,714.

(51) Int. Cl. G06F 9/00

(52) U.S. Cl. 713/2

(57) ABSTRACT

Methods and systems of booting an intelligent non-volatile memory (NVM) microcontroller from various sources are described. According to one aspect of the present invention, a NVM microcontroller comprises multiple memory interfaces. Each of the memory interfaces may connect to one of the various sources for booting. The sources may include random access memory (RAM), read-only memory (ROM), Electrically Erasable Programmable ROM (EEPROM) (e.g., NOR flash memory, NAND flash memory). RAM may include static RAM (SRAM), dynamic RAM (DRAM), and synchronous dynamic RAM (SDRAM). Other sources include Secure Digital (SD) card and intelligent non-volatile memory devices. The NAND flash memory may include single-level cell (SLC) flash or multi-level cell (MLC) flash. SLC flash uses a single level per cell or two states per cell, while MLC flash stores four, eight or more states per cell.

### CROSS-REFERENCE TO RELATED APPLICATIONS

This application is a continuation-in-part (CIP) of U.S. patent application for “Method and Systems of Managing Memory Addresses in a Large Capacity Multi-Level Cell (MLC) based Memory Device”, Ser. No. 12/025,706, filed on Feb. 4, 2008, which is a CIP application for “Flash Module with Plane-interleaved Sequential Writes to Restricted-Write Flash Chips”, Ser. No. 11/871,011, filed Oct. 11, 2007.

This application is also a CIP of U.S. patent application for “High Integration of Intelligent Non-Volatile Memory Devices”, Ser. No. 12/054,310, filed Mar. 24, 2008, which is a CIP of “High Endurance Non-Volatile Memory Devices”, Ser. No. 12/035,398, filed Feb. 21, 2008.

This application is also a CIP of U.S. patent application for “Electronic data Flash Card with Various Flash Memory Cells”, Ser. No. 11/864,671, filed Sep. 28, 2007, which is a CIP of U.S. patent application for “Managing Flash Memory Including Recycling Obsolete Sectors”, Ser. No. 10/789,333, filed Feb. 26, 2004, now issued as U.S. Pat. No. 7,318,117.

This application is also a CIP of U.S. patent application for “Flash Card System”, Ser. No. 10/957,089, filed on Oct. 1, 2004.

This application is also a CIP of U.S. patent application for “Single-Chip Multi-Media Card/Secure Digital controller Reading Power-on Boot Code from Integrated Flash Memory for User Storage”, Ser. No. 11/309,594, filed on Aug. 28, 2006, which is a CIP of U.S. patent Application for “Single-Chip USB Controller Reading Power-On Boot Code from Integrated Flash Memory for User Storage”, Ser. No. 10/707,277, filed on Dec. 2, 2003, now issued as U.S. Pat. No. 7,103,684.

This application is also a CIP of co-pending U.S. patent Application for “Electronic Data Storage Medium with Fingerprint Verification Capability”, Ser. No. 11/624,667, filed on Jan. 18, 2007, which is a divisional application of U.S. patent application Ser. No. 09/478,720, filed on Jan. 6, 2000, now U.S. Pat. No. 7,257,714 issued on Aug. 14, 2007.

### FIELD OF THE INVENTION

The invention relates to non-volatile memory devices, more particularly to systems and methods of booting of an intelligent non-volatile memory (NVM) microcontroller from various sources.

### BACKGROUND OF THE INVENTION

As flash memory technology becomes more advanced, flash memory is replacing traditional magnetic disks as storage media for mobile systems. Flash memory has significant advantages over floppy disks or magnetic hard disks such as having high-G resistance and low power dissipation. Because of the smaller physical size of flash memory, they are also more conducive to mobile systems. Accordingly, the flash memory trend has been growing because of its compatibility with mobile systems and low-power feature. However, advances in flash technology have created a greater variety of flash memory device types that vary for reasons of performance, cost and capacity. One of the usages is to replace or supplement hard disk drives of a computer system.

Flash memories use non-volatile memory cells such as electrically-erasable programmable read-only memory, (EEPROM), but are not randomly accessible at the byte level. Instead, whole pages or sectors of 512 bytes or more are read or written together as a single page. NAND flash memory is commonly used for data storage of blocks. Pages in the same block may have to be erased together, and limitations on writing may exist, such as only being allowed to write each page once between erases.

Program code is often stored in randomly-accessible memory such as a Read-Only Memory (ROM) or NOR flash memory. Since NOR flash memory is byte-addressable, NOR flash can store code that can be executed. Byte-addressing is needed to execute code, since branch and jump instructions may have a target that is at a random location that must be fetched next. The target may be byte-addressable. Since boot routines execute instructions one at a time, rather than a whole page at a time, randomly-accessible memory is needed for boot-code execution.

Small portable devices such as personal digital assistants (PDA), multi-function cell phones, digital cameras, music players, etc. have a central processing unit (CPU) or microcontroller that must be booted just as a Personal Computer (PC) or host CPU must be booted. These small devices are often quite cost and size sensitive. Having a NOR flash or ROM may increase the size and cost of these portable devices.

NAND flash memory is less expensive than NOR flash memory, and thus preferable from a cost standpoint. NAND flash memory may already be present on some devices such as cell phones or music players as the primary mass storage memory. It is thus desirable to use NAND flash memory to store boot code.

What is desired is a multi-bus-interface device that can access several different types of memory. Therefore, it would be desired to boot a processor inside a device using boot code that is stored in several of these different types of memory and it would be desirable to have improved methods and systems of booting an intelligent non-volatile memory (NVM) microcontroller from various sources.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Methods and systems of booting an intelligent non-volatile memory (NVM) microcontroller from various sources are disclosed. According to one aspect of the present invention, a NVM microcontroller comprises multiple memory interfaces. Each of the memory interfaces may connect to one of the various sources for booting. The sources may include random access memory (RAM), read-only memory (ROM), Electrically Erasable Programmable ROM (EEPROM) (e.g., NOR flash memory, NAND flash memory). RAM may include static RAM (SRAM), dynamic RAM (DRAM), and synchronous dynamic RAM (SDRAM). Other sources include Secure Digital (SD) card and intelligent non-volatile memory devices. The NAND flash memory may include single-level cell (SLC) flash or multi-level cell (MLC) flash. SLC flash uses a single level per cell or two states per cell, while MLC flash stores four, eight or more states per cell.

NOR flash allows random access while NAND flash allows only page access. In other words, the NOR flash is byte addressable and the NAND flash is sector/page/block addressable depending upon implementation. In NOR flash, cells are connected in parallel to the bit lines, allowing cells to be read and programmed individually. The parallel connection of cells resembles the parallel connection of transistors in a Complementary metal-oxide (CMOS) NOR gate. In NAND flash, cells are connected in series, resembling a NAND gate, and preventing cells from being read and programmed individually: the cells connected in series must be read in series.

Due to similarities between the Multi-Media Card (MMC) and SD standards (e.g., form factors and construction, locations of connectors, contact pads, etc.), MMC and SD cards are collectively referred to herein as “SD” cards.

According to another aspect of the present invention, the NVM microcontroller is configured to be booted from a ROM and a RAM with boot sequence firmware stored on an external non-volatile memory device (e.g., SD card). The NVM microcontroller may also be booted using first and second RAM (e.g., SRAM and DRAM). Due to the cost concern, SRAM is generally configured with a relatively smaller capacity, while DRAM with larger capacity.

According to yet another aspect of the present invention, smaller capacity SRAM can be used for other functions such as a logical-to-physical address lookup table or address correlation and page usage memory (ACPUM) after the booting procedure has completed. N sets of partial logical-to-physical address and page usage information (hereinafter ‘PLTPPUI’) are stored in the reserved area of the MLC based flash memory. Only one the N sets is loaded to address correlation and page usage memory (ACPUM), which is a limited size static random access memory (SRAM). LSA received together with the data transfer request dictates which one of the N sets of PLTPPUI is loaded into ACPUM.

According to yet another aspect of the present invention, the physical blocks designed for storing PLTPPUI is in the reserved area of the MLC based flash memory. The physical blocks located in the reserved area are referenced by a plurality of first special logical addresses used in the processing unit of the flash memory device. A PLTPPUI tracking table is configured to hold a plurality of entries containing correlations between a plurality first special logical addresses and its corresponding physical block number plus tracking number and highest page of the physical block. The PLTPPUI tracking table may be implemented in the SRAM. Similarly, a wear leveling counter and bad block indicator (WL/BB) tracking table is configured to track corresponding physical blocks to a set of second special logical addresses designated for storing the WL/BB information.

According one embodiment, the present invention is a method of booting a non-volatile memory microcontroller. The method comprises at least the following: activating a state machine on the microcontroller to read an initial boot loader module while the central processing unit (CPU) is in a reset state after detecting a power-on signal, wherein the initial boot loader is located in first page of first block of a non-volatile memory coupled to the microcontroller through a bus; writing the initial boot loader module to a first random access memory (RAM) in the microcontroller using the state machine; releasing the CPU from the reset state and executing the initial boot loader module on the CPU by fetching instructions of the initial boot loader module stored in the first RAM; copying next one or more pages, containing an extended boot sequence module, from the non-volatile memory to a second RAM via a buffer located in the first RAM in response to the instructions of the initial boot loader module; executing instructions of the extended boot sequence module after the CPU has finished executing all of the instructions of the initial boot loader module; copying next one or more pages, containing a complete boot sequence module, from the non-volatile memory to the second RAM via the buffer area as the extended boot sequence module is being executed; and executing instructions of the complete boot sequence module after the CPU has finished executing all of the instructions of the extended boot sequence module.

According to another embodiment, the present invention is a non-volatile memory (NVM) microcontroller. The microcontroller comprises at least the following: a NVM bus for connecting to at least one NVM chip, the NVM bus carrying addresses, data and commands to the at least one NVM chip; wherein the at least one NVM chip stores a first group of instructions and a second group of instructions; an internal bus; a first random-access memory (RAM), coupling to the internal bus, configured for holding a copy of the first group of instructions for execution; a second RAM, coupling to the internal bus, configured for holding a copy of the second group of instructions for execution; wherein the first RAM and the second RAM are volatile memories that lose data when power is removed; a central processing unit (CPU), coupling to the internal bus, configured for accessing and executing the first group of instructions in the first RAM during a first mode and for accessing and executing the second group of instructions in the second RAM during a second mode; a NVM controller, coupling to the internal bus, configured for generating NVM control signals and configured for buffering commands, addresses, and data to the NVM bus; an initializer configured for activating the NVM controller to copy the first group of instructions from the at least one NVM chip to the first RAM; a first module loaded on the CPU and executed by the CPU while in the first mode after the reset signal is de-asserted, the first module contains the first group of instructions stored in the first RAM, wherein the first module activates the NVM controller to copy the second group of instructions from the at least one NVM chip to the second RAM; and a second module loaded on the CPU and executed by the CPU while in the second mode, the second module contains the second group of instructions stored in the second RAM, wherein the first and second modules are used for booting the NVM microcontroller.

According to yet another embodiment, the present invention is a multi-interface microcontroller that comprises at least the following: flash bus means for connecting to a flash memory, the flash bus means carrying addresses, data, and commands to the flash memory; wherein the flash memory stores an initial boot loader, an extended boot sequence, and a complete boot sequence in non-volatile memory; first volatile memory means for storing first instructions for execution; second memory interface means for interfacing to a second volatile memory means for storing second instructions for execution; processor means for fetching and executing the first instructions in the first volatile memory means during a first mode and fetching and executing the second instructions from the second volatile memory means during a second mode; flash-memory controller means for generating flash-control signals and for buffering commands, addresses, and data to the flash bus means; hardwired initializer means, activated by a reset signal, for activating the flash-memory controller means to read the initial boot loader from the flash memory, and for writing the initial boot loader as the first instructions to the first volatile memory means; initial boot loader execution means for activating the processor means to fetch and execute the first instructions from the first volatile memory means, the initial boot loader execution means for activating the flash-memory controller means to read the extended boot sequence from the flash memory, and for writing the extended boot sequence as the second instructions to the second volatile memory means; and extended boot sequence execution means for activating the processor means to fetch and execute the second instructions from the second volatile memory means, the extended boot sequence execution means for activating the flash-memory controller means to read the complete boot sequence from the flash memory, and for writing the complete boot sequence as additional second instructions to the second volatile memory means.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a block diagram showing salient components of a first flash memory device (with fingerprint verification capability), in which an embodiment of the present invention may be implemented;

FIG. 1B is a block diagram showing salient components of a second flash memory device (without fingerprint verification capability), in which an embodiment of the present invention may be implemented;

FIG. 1C is a block diagram showing salient components of a flash memory system embedded on a motherboard, in which an embodiment of the present invention may be implemented;

FIG. 1D is a block diagram showing salient components of a flash memory module coupling to a motherboard, in which an embodiment of the present invention may be implemented;

FIG. 2A is a block diagram depicting an intelligent microcontroller with multiple memory interfaces, according one embodiment of the present invention;

FIG. 2B is a block diagram depicting an intelligent microcontroller with multiple memory interfaces and without a separate NOR flash memory, according one embodiment of the present invention;

FIG. 2C is a block diagram depicting an intelligent microcontroller with multiple memory interfaces including separated multiple memories (e.g., SRAM and DRAM), according one embodiment of the present invention

FIG. 3 is a functional block diagram illustrating salient components of an exemplary NVM microcontroller (SD flash microcontroller), according to an embodiment of the present invention;

FIG. 4A is a diagram showing an exemplary data structure of a NAND flash memory;

FIG. 4B is a diagram showing locations of boot sequence module stored in a NAND flash memory;

FIG. 5 is a block diagram showing an exemplary microcontroller for a large capacity NVMD (e.g., MLC based flash memory device), according to one embodiment of the present invention;

FIG. 6 is a flowchart illustrating an exemplary process of booting a NVMD microcontroller, according to an embodiment of the present invention;

FIG. 7 is a diagram showing an exemplary booting scheme of a SD flash microcontroller from multiple memories in accordance with one embodiment of the present invention; and

FIGS. 8A-B collectively is a flowchart illustrating an exemplary process of booting a microcontroller from multiple memories, according to an embodiment of the present invention.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

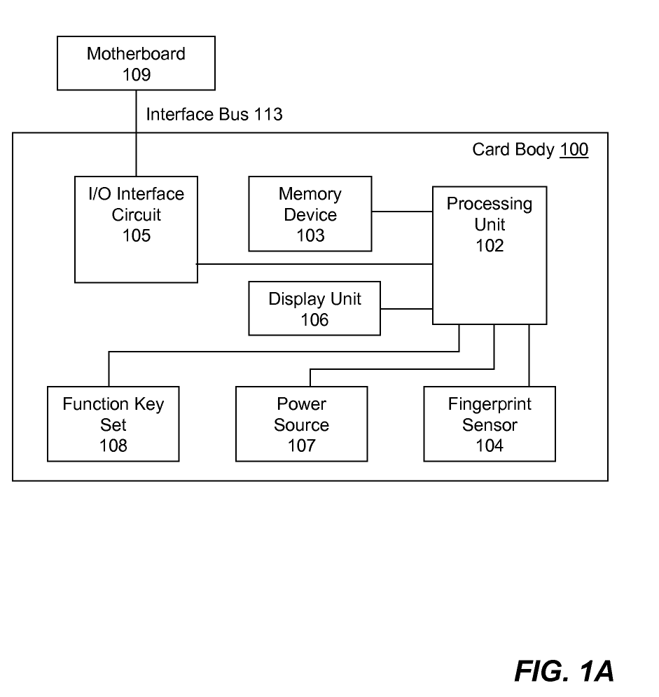

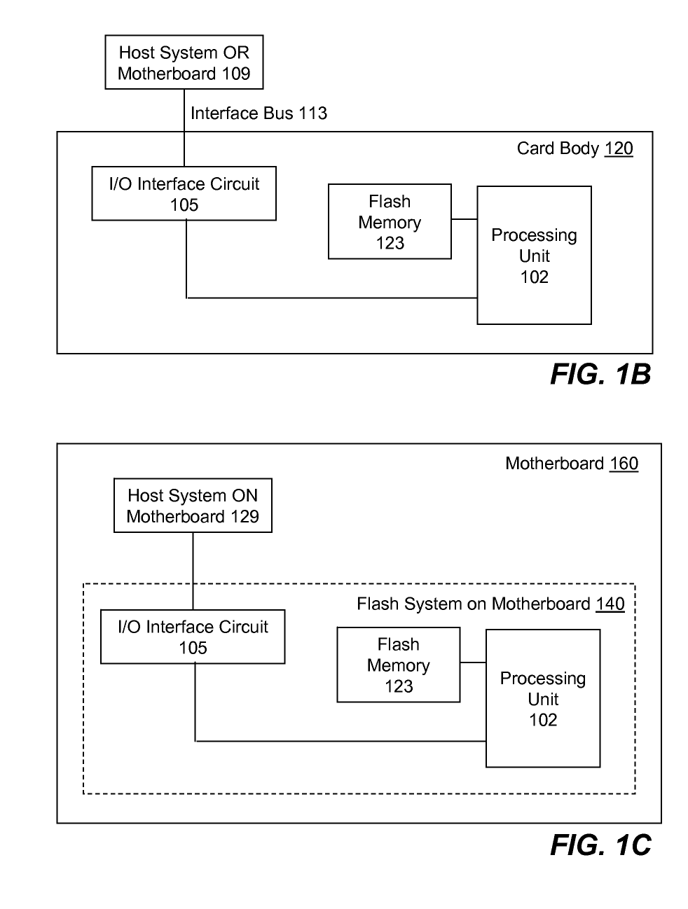

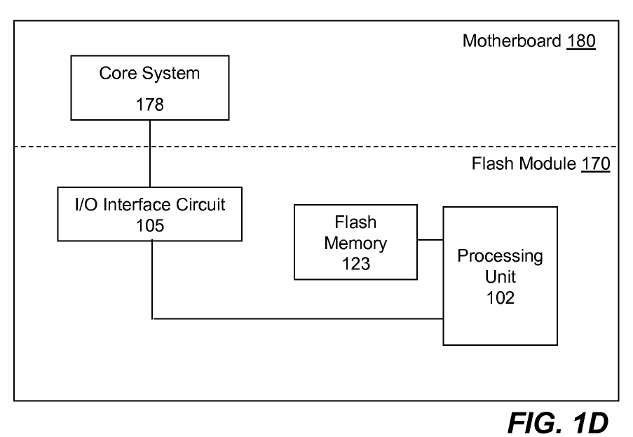

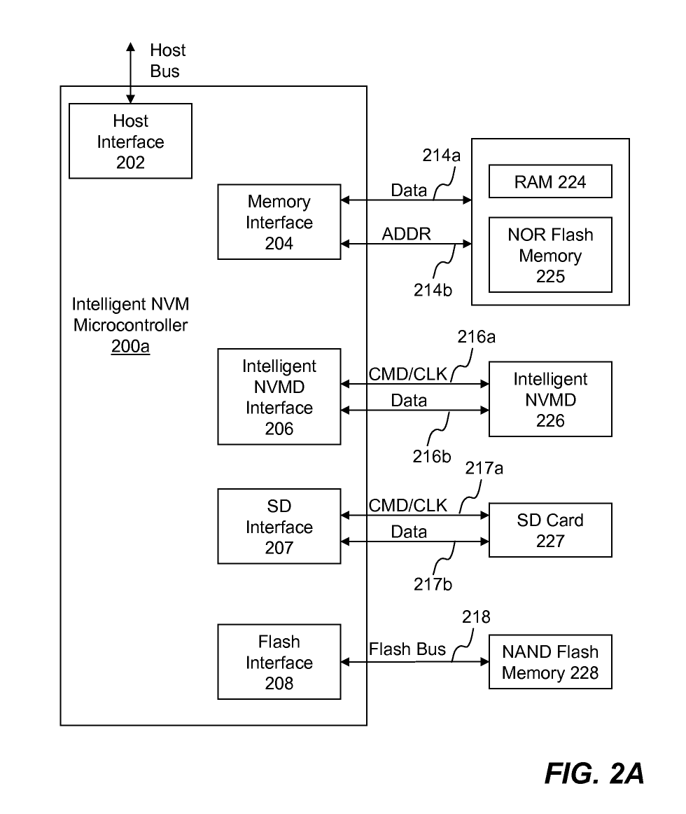

Embodiments of the present invention are discussed herein with reference to FIGS. 1A-9B. However, those skilled in the art will readily appreciate that the detailed description given herein with respect to these figures is for explanatory purposes as the invention extends beyond these limited embodiments.

FIG. 1A is a block diagram illustrating salient components of a first flash memory device (with fingerprint verification capability), in which an embodiment of the present invention may be implemented. The first flash memory device is adapted to a motherboard 109 via an interface bus 113. The first flash memory device includes a card body 100, a processing unit 102, memory device 103, a fingerprint sensor 104, an input/output (I/O) interface circuit 105, an optional display unit 106, an optional power source (e.g., battery) 107, and an optional function key set 108. The motherboard 109 may be a motherboard of a desktop computer, a laptop computer, a mother board of a personal computer, a cellular phone, a digital camera, a digital camcorder, a personal multimedia player or any other computing or electronic devices.

The card body 100 is configured for providing electrical and mechanical connection for the processing unit 102, the memory device 103, the I/O interface circuit 105, and all of the optional components. The card body 100 may comprise a printed circuit board (PCB) or an equivalent substrate such that all of the components as integrated circuits may be mounted thereon. The substrate may be manufactured using surface mount technology (SMT) or chip on board (COB) technology.

The processing unit 102 and the I/O interface circuit 105 are collectively configured to provide various control functions (e.g., data read, write and erase transactions) of the memory device 103. The processing unit 102 may also be a standalone microprocessor or microcontroller, for example, an 8051, 8052, or 80286 Intel® microprocessor, or ARM®, MIPS® or other equivalent digital signal processor. The processing unit 102 and the I/O interface circuit 105 may be made in a single integrated circuit, for application specific integrated circuit (ASIC).

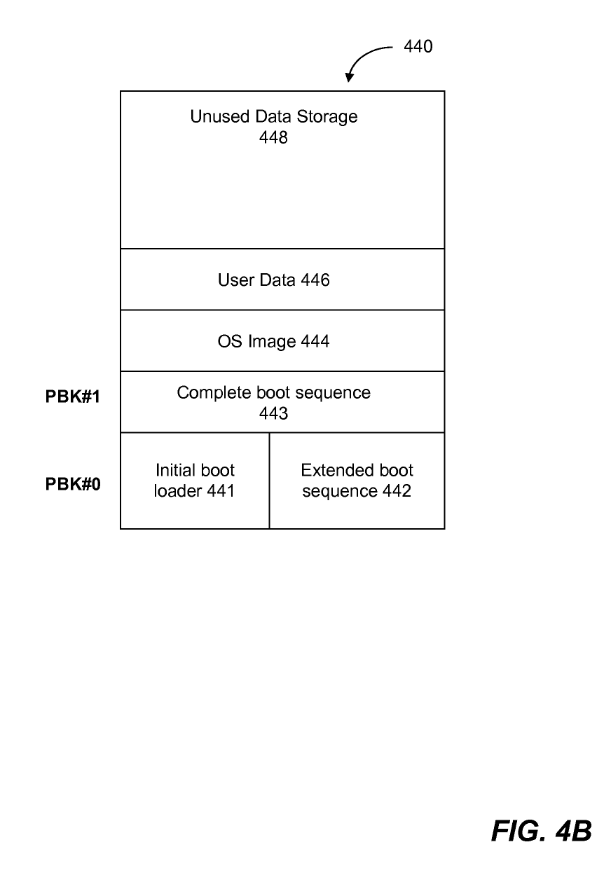

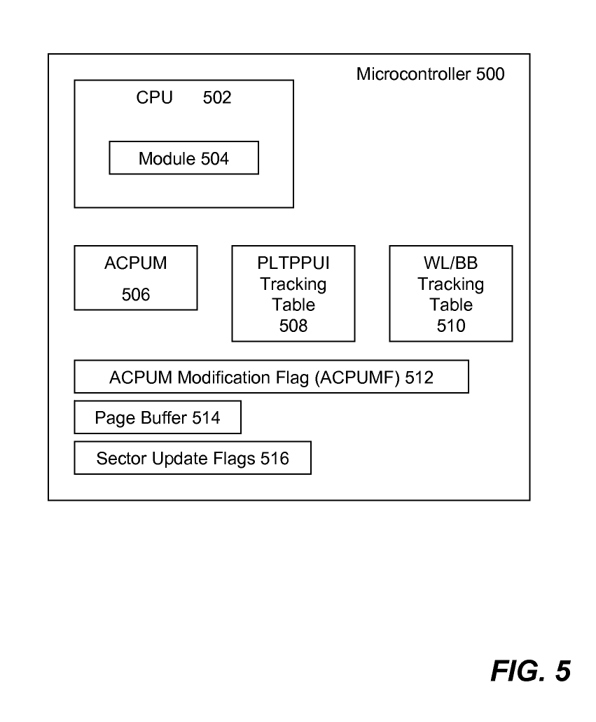

The memory device 103 may comprise one or more non-volatile memory (e.g., flash memory) chips or integrated circuits. The flash memory chips may be single-level cell (SLC) or multi-level cell (MLC) based. In SLC flash memory, each cell holds one bit of information, while more than one bit (e.g., 2, 4 or more bits) are stored in a MLC flash memory cell. A detail data structure of an exemplary flash memory is described and shown in FIG. 4A and corresponding descriptions thereof.

The fingerprint sensor 104 is mounted on the card body 100, and is adapted to scan a fingerprint of a user of the first electronic flash memory device 100 to generate fingerprint scan data. Details of the fingerprint sensor 104 are shown and described in a co-inventor's U.S. Pat. No. 7,257,714, entitled “Electronic Data Storage Medium with Fingerprint Verification Capability” issued on Aug. 14, 2007, the entire content of which is incorporated herein by reference.

The memory device 103 stores, in a known manner therein, one or more data files, a reference password, and the fingerprint reference data obtained by scanning a fingerprint of one or more authorized users of the first flash memory device. Only authorized users can access the stored data files. The data file can be a picture file, a text file or any other file. Since the electronic data storage compares fingerprint scan data obtained by scanning a fingerprint of a user of the device with the fingerprint reference data in the memory device to verify if the user is the assigned user, the electronic data storage can only be used by the assigned user so as to reduce the risks involved when the electronic data storage is stolen or misplaced.

The input/output interface circuit 105 is mounted on the card body 100, and can be activated so as to establish communication with the motherboard 109 by way of an appropriate socket via an interface bus 113. The input/output interface circuit 105 may include circuits and control logic associated with a Universal Serial Bus (USB) interface structure that is connectable to an associated socket connected to or mounted on the motherboard 109. The input/output interface circuit 105 may also be other interfaces including, but not limited to, Secure Digital (SD) interface circuit, Micro SD interface circuit, Multi-Media Card (MMC) interface circuit, Compact Flash (CF) interface circuit, Memory Stick (MS) interface circuit, PCI-Express interface circuit, a Integrated Drive Electronics (IDE) interface circuit, Serial Advanced Technology Attachment (SATA) interface circuit, external SATA, Radio Frequency Identification (RFID) interface circuit, fiber channel interface circuit, optical connection interface circuit.

The processing unit 102 is controlled by a software program module (e.g., a firmware (FW)), which may be stored partially in a ROM (not shown) such that processing unit 102 is operable selectively in: (1) a data programming or write mode, where the processing unit 102 activates the input/output interface circuit 105 to receive data from the motherboard 109 and/or the fingerprint reference data from fingerprint sensor 104 under the control of the motherboard 109, and store the data and/or the fingerprint reference data in the memory device 103; (2) a data retrieving or read mode, where the processing unit 102 activates the input/output interface circuit 105 to transmit data stored in the memory device 103 to the motherboard 109; or (3) a data resetting or erasing mode, where data in stale data blocks are erased or reset from the memory device 103. In operation, motherboard 109 sends write and read data transfer requests to the first flash memory device 100 via the interface bus 113, then the input/output interface circuit 105 to the processing unit 102, which in turn utilizes a flash memory controller (not shown or embedded in the processing unit) to read from or write to the associated at least one memory device 103. In one embodiment, for further security protection, the processing unit 102 automatically initiates an operation of the data resetting mode upon detecting a predefined time period has elapsed since the last authorized access of the data stored in the memory device 103.

The optional power source 107 is mounted on the card body 100, and is connected to the processing unit 102 and other associated units on card body 100 for supplying electrical power (to all card functions) thereto. The optional function key set 108, which is also mounted on the card body 100, is connected to the processing unit 102, and is operable so as to initiate operation of processing unit 102 in a selected one of the programming, data retrieving and data resetting modes. The function key set 108 may be operable to provide an input password to the processing unit 102. The processing unit 102 compares the input password with the reference password stored in the memory device 103, and initiates authorized operation of the first flash memory device 100 upon verifying that the input password corresponds with the reference password. The optional display unit 106 is mounted on the card body 100, and is connected to and controlled by the processing unit 102 for displaying data exchanged with the motherboard 109.

A second flash memory device (without fingerprint verification capability) is shown in FIG. 1B. The second flash memory device includes a card body 120 with a processing unit 102, an I/O interface circuit 105 and at least one flash memory chip 123 mounted thereon. Similar to the first flash memory device, the second flash memory device couples to a motherboard or a host computing system 109 via an interface bus 113. Fingerprint functions such as scanning and verification may be handled by the host system 109.

FIG. 1C shows a flash memory system 140 integrated with a motherboard 160. Substantially similar to the second flash memory device 120 for FIG. 1B, the flash system 140 contains a processing unit 102, an I/O interface circuit 105 and at least one flash memory chip 123. Included on the motherboard 160, there is a host system 129 and the flash system 140. Data, command and control signals for the flash system 140 are transmitted through an internal bus.

FIG. 1D shows a flash memory module 170 coupling to a motherboard 180. The flash memory module 170 comprises a processing unit 102 (e.g., a flash controller), one or more flash memory chips 123 and an I/O interface circuit 105. The motherboard 180 comprises a core system 178 that may include CPU and other chip sets. The connection between the motherboard and the flash memory module 170 is through an internal bus such as a Peripheral Component Interconnect Express (PCI-E). The flash memory module 170 may be implemented as a single chip, a single substrate, single chip carrier, single die on a wafer or a single chip scaled package.

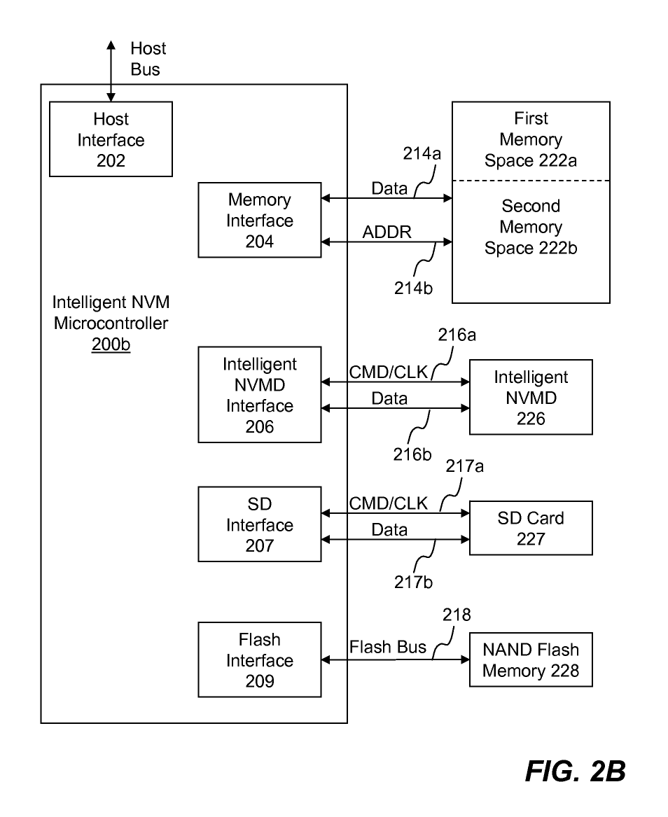

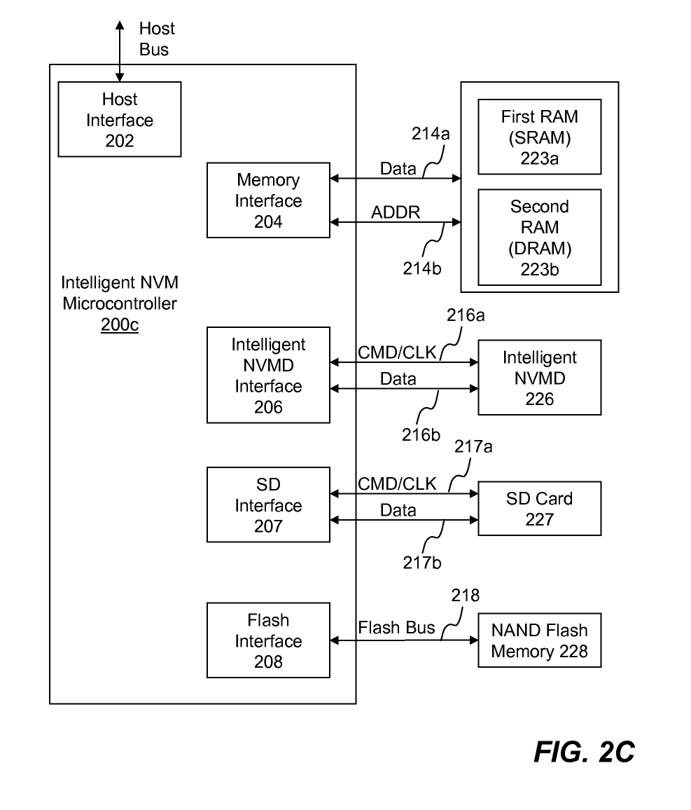

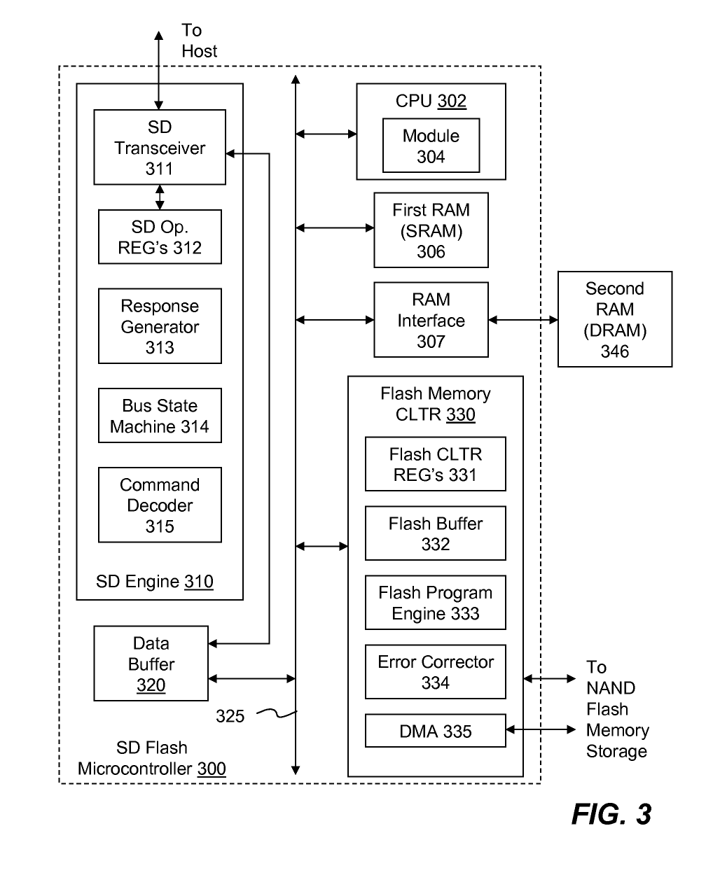

Referring now to FIG. 2A, which is a functional block diagram depicting an intelligent non-volatile memory (NVM) microcontroller 200a with multiple memory interfaces, according one embodiment of the present invention. The microcontroller 200a is configured to be booted from various memory sources. The microprocessor 200a comprises a memory interface 204, an intelligent NVM device interface 206, a secure digital (SD) card interface 207, a flash interface 208 and an optional host interface 202. The memory interface 204 is configured to facilitate data read and write from a RAM 224 via a data bus 214a and an address bus 214b. A NOR flash memory 225 can also be connected to the same data and address buses 214a-b such that data stored on the NOR flash memory 225 can be read through the memory interface 204 to the microcontroller 200a.

The intelligent NVM device interface 206 is configured to facilitate data access to and from an intelligent non-volatile memory device (NVMD) 226 via a command/clock (CMD/CLK) bus 216a and a corresponding data bus 216b. In one embodiment, the data access of the intelligent NVMD 226 is conducted in accordance with one of the industry standards (e.g., Open NAND Flash Interface (ONFi)). The SD interface 207 is configured to facilitate data packets transmission to and from a SD card 227 via a CMD/CLK bus 217a and a corresponding data bus 217b. The flash interface 208 is configured to data transfer operations to and from a NAND flash memory 228 via a flash bus 218. The data transfer operations include data read, write (program) and erase operations. The NAND flash memory 228 is referred to as a raw flash memory.

A host such as a PC may connect to the microcontroller 200a over the SD buses 217a-b, the intelligent NVMD buses 216a-b or over the host bus 202. The host bus 202 is optional and not needed when the host connects over the intelligent NVMD buses 216a-b or the SD buses 217a-b. Similarly, the intelligent NVMD interface 206 may be optional for at least the same reason above.

Shown in FIG. 2B, there is shown a second microcontroller 200b, an alternative to the first microcontroller 200a. The difference is that there is only one memory 222 without a separate NOR flash memory 225 shown in FIG. 2A. Instead, a state machine or other hardwired logic inside the second microcontroller 200b acts as an initial boot loader, which reads boot sequence modules stored in the NAND flash memory 228 (e.g., first page of the flash memory). In this embodiment, the SD interface 207 is configured to read the initial boot loader code or sequence from the NAND flash memory 228. Also the memory 222 may comprise a first memory space 222a and a second memory space 222b. The first memory space 222a may be a read-only memory (ROM), a static RAM, a cache, a relatively smaller capacity RAM or a portion of a RAM. The second memory space 222b may be an internal RAM, an external RAM, dynamic RAM, a relatively larger capacity RAM.

FIG. 2C is a block diagram showing a third NVMD microcontroller 200c, which is another alternative to first and second microcontrollers 200a-b. The third microcontroller 200c includes a combination of first and second random access memories 223a-b (e.g., SRAM 223a and DRAM 223b). The memory interface 204 is configured to generate both control signals for the first and second memories 223a-b, for example, pulsed control signals Row Address Strobe (RAS), Column Address Strobe (CAS). The memory addresses may also be multiplexed for row and column addresses. In general, the second memory 223b is a larger capacity memory (i.e., lower cost memory), while the first memory 223a is a smaller size or capacity memory (i.e., higher performance with higher costs). Additionally, when the second memory 223b is a DRAM, the memory interface 204 needs to generate DRAM control signals to ensure DRAM is refreshed, either using external refresh or an internal refresh controller within the DRAM. Furthermore, the NAND flash memory 228 is shown to reside on the flash bus 218 in FIG. 2C. The NAND flash memory 228 may be reside on either the SD buses 217a-b or the intelligent NVMD buses 216a-b in other embodiments.

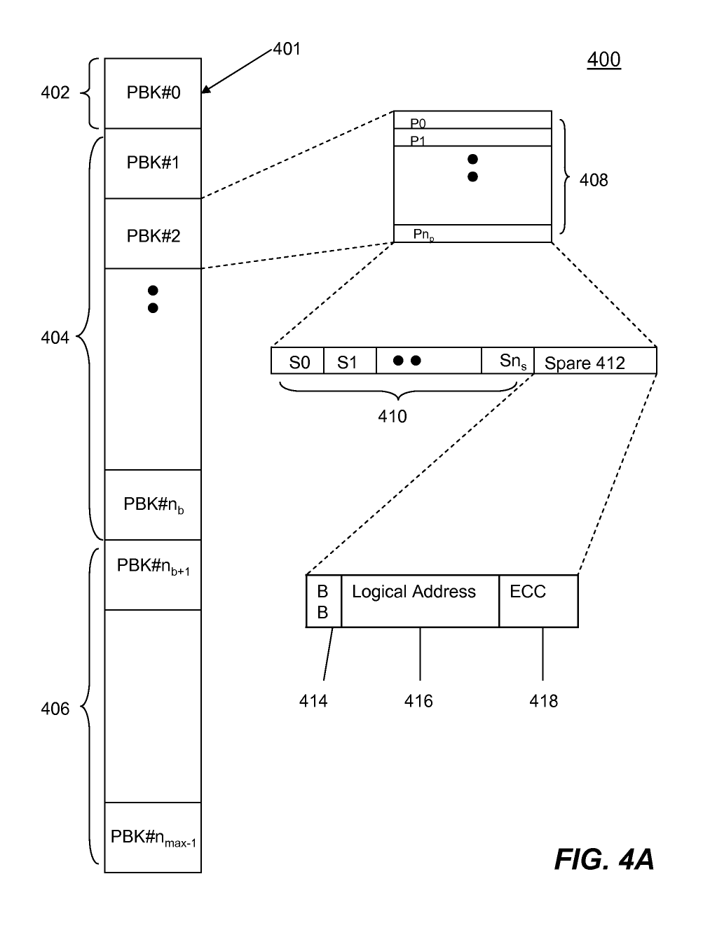

FIG. 3 is a functional block diagram illustrating salient components of an exemplary NVM microcontroller (SD flash microcontroller 300), according to an embodiment of the present invention. The SD flash microcontroller 300 may be configured to be booted from external flash memory in this embodiment.

The SD flash microcontroller 300 comprises an internal bus 325. Components coupling to the internal bus include a central processing unit (CPU) 302, first RAM 306, RAM interface 307, a flash memory controller 330, a data buffer 320 and a SD engine 310. The CPU 302 is configured to execute instructions of one or more modules 304 installed thereon. The modules 304 may be stored in a ROM (not shown), the first RAM 306, a second RAM 346 or a NAND flash memory. The second RAM 346 may be external or internal to the SD flash microcontroller 300. If the second RAM 346 is external, the access is through a RAM interface 307. The first RAM 306 may be SRAM, while the second RAM may be DRAM. The data buffer 320 is configured to hold data to be transferred. The CPU 302 may also include cache memory (not shown) to improve performance and endurance of the SD microcontroller 300. The data buffer 320 may be configured to be accessed in a first-in-first-out (FIFO) manner.

The flash memory controller 330 comprises one or more flash control registers 331, a flash data buffer 332, a flash programming engine 333, an error corrector 334 and a direct memory access (DMA) engine 335. The DMA engine 335 is configured to transfer data between the data buffer 320 and flash memory controller 330 and the NAND flash memory. The flash data buffer 332 contains commands, addresses and data sent over to the NAND flash memory. Data can be arranged in the flash data buffer 332 to ensure more efficient and effective data transfer, for example, matching data bus width (e.g., 8-, 16-, 32- or 64-bit), interleaving data, etc.

The flash control registers 331 may be used in conjunction with the flash data buffer 332, or may be a part of flash data buffer 332. Flash-specific registers in the flash control registers 331 may include a data port register, interrupt, flash command and selection registers, flash-address and block-length registers and cycle registers.

The error corrector 334 is configured to process parity or error-correction code (ECC) to and from the flash memory to ensure certain level of errors in the data can be corrected. The flash programming engine 333 can be a state machine that is activated on power-up reset. The flash programming engine 333 programs the DMA engine 335 with the address of the boot loader code in the first page of the external flash mass-storage chip, and the first address in cache or in the first RAM 306, or in external second RAM 346 through RAM interface 307. Then flash programming engine 333 commands DMA engine 335 to transfer the boot loader from the flash mass storage chip to cache or the first small RAM 306, or to the external RAM 346. CPU 302 is then brought out of reset, executing the boot loader program starting from the first address in cache or the first RAM 306. The boot loader program can contain instructions to move a larger control module from the flash mass storage chip to external RAM 346 through RAM interface 307. Thus the SD flash microcontroller 300 can be booted without an internal ROM on internal bus 325.

The SD engine 310 comprises a SD transceiver 311, one or more SD operating registers 312, a response generator 313 a bus state machine 314 and a command decode and validation engine 315. The SD transceiver 311 connects to the clock (CLK) and corresponding parallel data lines of the SD bus 216 and contains both a clocked receiver and a transmitter. An interrupt to CPU 302 can be generated when a new command is detected on SD bus 216. CPU 302 can then execute a routine to handle the interrupt and process the new command.

The command decode and validation engine 315 detects, decodes and validates commands received over SD bus 216. Valid commands may alter bus-cycle sequencing by the bus state machine 314, and may cause the response generator 313 to generate a response, such as an acknowledgement or other reply. Different routines can be executed by CPU 302 or different transfer lengths can be performed by DMA engine 335 in response to the byte or sector capacity detected by the command decode and validation engine 315.

The transmitted and received data from the SD engine 310 is stored in the data buffer 320 after passing through a data port register in the SD operating registers 312. Commands and addresses from the SD transactions can also be stored in the data buffer 320, to be read by CPU 302 to determine what operation to perform.

Referring now to FIG. 4A, which is a diagram depicting an exemplary data structure 400 of a flash memory module 401 (e.g., flash memory module 103 of FIG. 1B) in accordance with one embodiment of the present invention. The flash memory module 401 is divided into a plurality of physical blocks e.g., PBK#0, PBK#1, PBK#2, . . . ). In general, there are three categories of physical blocks: 1) the first block 402 (i.e., PBK#0); 2) normal usage data blocks 404 (i.e., PBK#1, PBK#2, . . . , PBK#n_{b}); and 3) reserved blocks 406 (i.e., PBK#n_{b+1}, . . . PBK#nₘₐₓ₋₁). The first block (PBK#0) 402 is guaranteed to be a good block and used by the manufacturer to store certain information such as Flash Timing Parameter (FTP), and other information by Initial Manufacturing Program (IMP), which cannot be alter by users. The manufacturer may define a percentage (e.g., 95%) of the total capacity as normal usage data blocks and the rest as reserved. The normal usage data blocks 404 are configured for user to store user data, although the first block (i.e., PBK#1) of the normal usage data blocks 404 is generally used for storing Master Boot Record (MBR), which contains critical data for operation of a computing device. Lastly, the reserved blocks 406 are configured to be accessed by a program module (e.g., FW) via special memory addresses in accordance with one embodiment of the present invention. Examples of the special memory address are 0xFFFF0000, 0xFFFF0001, 0xFFFFFF00, 0xFFFFFF01, etc.

Each block is further divided into a plurality of pages 408 (e.g., P0, P1, . . . , Pnₚ). Each of the pages 408 includes a data area 410 and a spare area 412. The data area is partitioned into a plurality of sectors (e.g., S0, S1, . . . , Sn_{S}). In one embodiment, each sector stores 512-byte of data. The spare area 412 is configured to provide three different fields: 1) a bad block (BB) indicator 414, a logical address area 416 and an error correction code (ECC) area 418. When a block is tested no good by the manufacturer, the bad block indicator 414 of that block is set to a special code to indicate a bad block that cannot be used. The logical address area 16 is configured for identifying of that particular physical block for initialization of the flash memory device. The ECC area 418 is configured to store the ECC for ensuring data integrity.

In order to access the data stored in the normal usage blocks 404 of the flash memory module 401, a host (e.g., PC, electronic device) transmits a data transaction request (e.g., data read or write) along with a logical sector address (LSA) to the flash memory device (e.g., flash memory device 100b of FIG. 1B). The processing unit 102 of the flash memory device converts the received LSA into a physical address (i.e., specific block, page and sector numbers) before any data transaction can be performed. Traditionally, the conversion is performed by an address look up table with a one-to-one relationship to the physical address. This solution works for a flash memory device with relatively small capacity, because the address look up table is implemented with a static random access memory (SRAM). It would not be feasible in terms of cost and physical space to include SRAM that grows linearly as the capacity of the flash memory device especially for a large capacity MLC based flash memory device. For example, a large capacity (say 32 Giga-Byte (GB)) MLC based flash memory device using 2112-byte page (i.e., 2048-byte data plus 64-byte spare) and 128 pages per block, it would require more than 2 MB bytes of SRAM to hold the entire address look up table.

FIG. 4B is a diagram showing locations of boot sequence module stored in a NAND flash memory 440 (e.g., flash memory module 401 of FIG. 4A). The NAND flash memory 440 is block-accessible, allowing pages in a block to be written just once before the whole block must be erased. Entire pages are read as a 512-byte page; individual bytes cannot be read or written.

The NAND flash memory 440 stores initial boot loader 441 at the first page of the first block (i.e., PBK#0). Extended boot sequence 442 is also stored in the first block in the pages right after initial boot loader 441 is stored. Complete boot sequence 443 is stored in the next block (e.g., PBK#1). Operating System (OS) image 444 is stored next, after the complete boot sequence 443. User data 446 is the main user or application data stored by flash memory 440. Unused user storage 448 is available for storing new data.

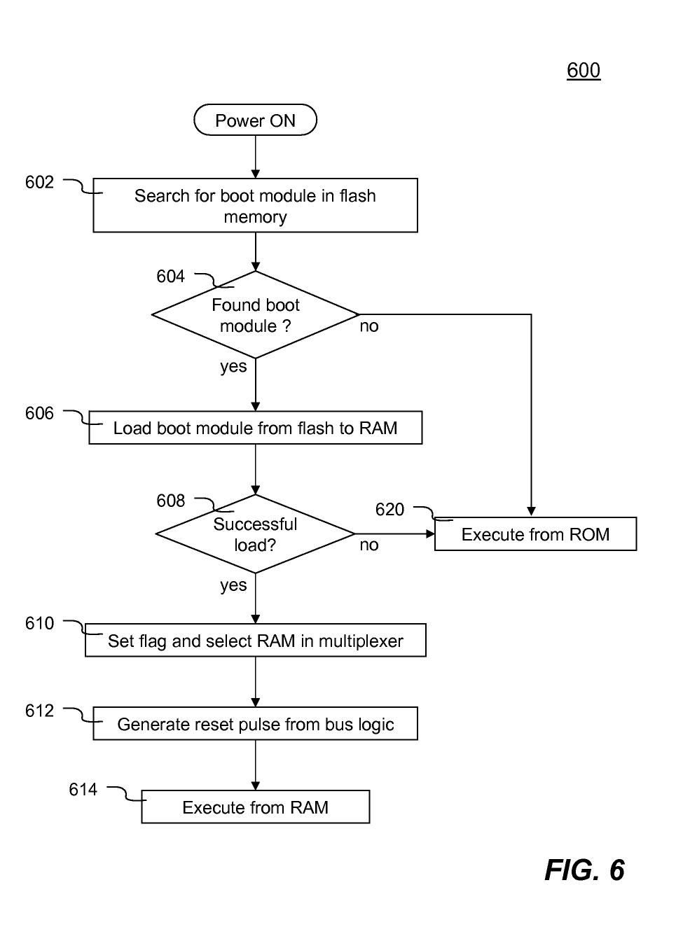

FIG. 5 is a block diagram showing an exemplary NVMD microcontroller 500 for a large capacity NVMD (e.g., MLC based flash memory device), according to one embodiment of the present invention. The microcontroller 500 comprises a CPU 502 with one or more modules 504 installed thereon. There are a number of tables and register flags configured on the microcontroller 500 including an address correlation and page usage memory (ACPUM) 506, a partial logical-to-physical address and page usage information (PLTPPUI) tracking table 508, a wear leveling and bad block (WL/BB) tracking table 510, a ACPUM modification flag (ACPUMF) 512, a page buffer 514 and a set of sector update flags 516.

The CPU 502 with a flash memory controlling program module 504 (e.g., a firmware (FW)) installed thereon is configured to control the data transfer between the host computing device and the at least one flash memory module 103. The ACPUM 506 is configured to provide an address correlation table, which contains a plurality of entries, each represents a correlation between a partial logical block address (i.e., entries) to the corresponding physical block number. In addition, a set of page usage flags associated with the physical block is also included in each entry. The ACPUM 506 represents only one of the N sets of PLTPPUI, which is stored in the reserved area of the flash memory. In order to keep tracking the physical location (i.e., physical block number) of each of the N sets of PLTPPUI, the physical location is stored in the PLTPPUI tracking table 508. Each item is the PLTPPUI tracking table 508 corresponds a first special logical address to one of the N sets of PLTPPUI. The wear leveling counters and bad block indicator for each physical block is stored in a number of physical blocks referred by corresponding second special logical addresses (e.g., ‘0xFFFFFF00’). The WL/BB tracking table 510 is configured to store physical block numbers that are assigned or allocated for storing these physical block wear leveling counters and bad blocks. The ACPUM modification flag (ACPUMF) 512 is configured to hold an indicator bit that tracks whether the ACPUM 506 has been modified or not. The page buffer 514 is configured to hold data in a data transfer request. The page buffer 514 has a size equaling to the page size of the flash memory 401. The sector update flags 516 are configured to hold valid data flag for each of the corresponding sectors written into data area of the page buffer 514. For example, four sector update flags are be required for a page buffer comprising four sectors. The page buffer 514 also includes a spare area for holding other vital information such as error correction code (ECC) for ensuring data integrity of the flash memory.

ACPUM 506 may be implemented in SRAM, the PLTPPUI tracking table 508 and the WL/BB tracking table 510 may be implemented in DRAM. And these memories (i.e., SRAM and DRAM) may be served as another purpose for booting up the microcontroller 500 after power-on reset.

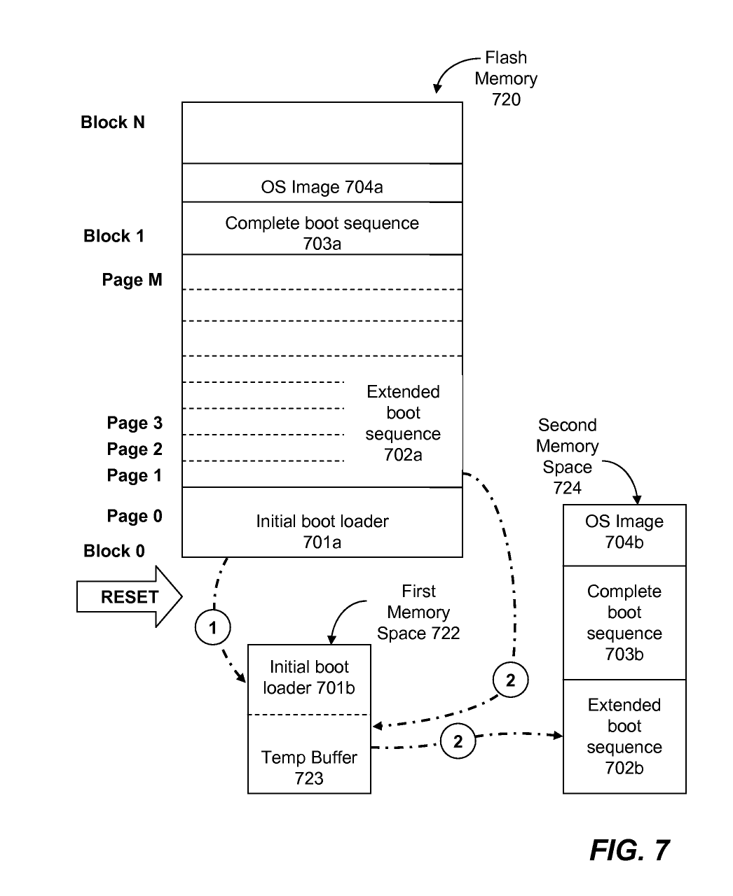

FIG. 6 is a flowchart illustrating an exemplary process 600 of booting a NVMD microcontroller from a first memory space (e.g., ROM) and a second memory space (e.g., RAM), according to an embodiment of the present invention.

The process 600 starts when power is applied and the CPU comes out of reset. At step 602, the process 600 searches an initial boot code or module in the flash memory. The boot module may be located in the first page of the first block of the flash memory. Some flash memory chip may automatically transfer this data after a reset or power-on. The existence of the boot code can be determined by matching a special signature or other data in the first few bytes of the first page. For example, a special flag “AA55” may be placed at the beginning of the boot code and the logic can check for this value to determine whether the search is successful.

At the decision 604, it is determined whether the initial boot module is found. If ‘no’, the process 600 connects the first memory space to the CPU. The boot code is read from the first memory space and executed on the CPU at step 620. Otherwise, the process 600 follows the “yes” branch to step 606. The boot module is loaded from the flash memory to the second memory space, which could be an external RAM or internal RAM. Next, at decision 608, it is determined whether the loading of the boot module is successful. If ‘no’, the process 600 moves to step 620, in which the boot module is read from the first memory space and executed on the CPU.

If ‘yes’, the process 600 moves to step 610, in which the second memory space is connected to the CPU. The CPU receives a reset pulse at step 612, and the CPU reads instructions from the first address of the second memory space, which is the boot loader module earlier loaded from the flash memory in step 606. Boot code is then read from the second memory space and executed on the CPU at step 614. Once the OS is loaded, user programs or other applications can be executed.

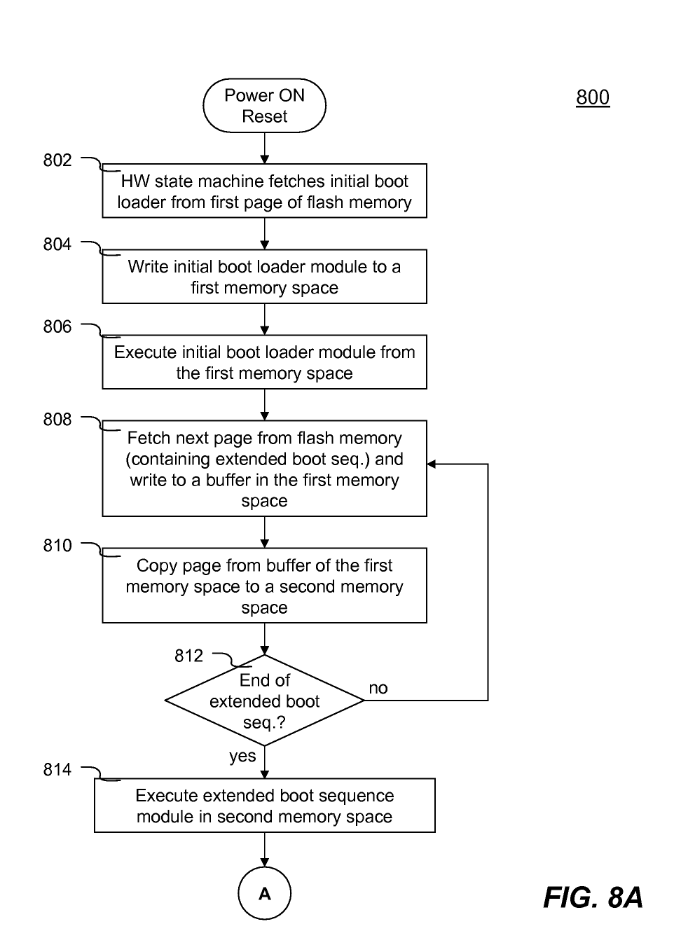

FIG. 7 is a diagram showing an exemplary booting scheme of a SD flash microcontroller from multiple memories in accordance with one embodiment of the present invention. Multiple memories may include a first memory space 722 and a second memory space 724. Both first and second memory space are volatile, losing all data stored when power is lost.

The first memory space 722 can be a small capacity RAM resided on the SD flash microcontroller 300. The first memory space 722 can also be a SRAM that is used for booting and other purposes after the booting has been completed. For example, the first memory space 722 could be part of a memory array that includes cache and FIFO buffer shown in FIG. 3. The first memory space 722 could be as small as two pages (i.e., 1,024-bytes) in size. The second memory space 724 can be external to the SD flash microcontroller 300. The flash memory 720 is non-volatile, retaining data stored such as boot module when power is lost. However, modules cannot be executed directly from flash memory 720, since flash memory 720 is block-addressable. A whole page must be read from flash memory 720, rather than individual cache lines or instructions.

After reset, a state machine or other hardware in the SD flash microcontroller 300 reads the first page of the first block of flash memory 720. This first page contains initial boot loader 701a, which is written by the hardware state machine into the first memory space 722. Initial boot loader 701a may occupy the entire 512-byte first page, or just part of the first page, or multiple pages.

After loading initial boot loader 701a into the first memory space 722, the CPU 302 exits the reset and begins fetching instructions from the first address in the first memory space 722. Initial boot loader copy 701b is located there, causing initial boot loader copy 701b to be executed directly by the CPU 302. Initial boot loader copy 701b contains instructions that cause the CPU 302 to read the remaining pages in the first block of flash memory 720. These pages contain extended boot sequence 702a. The remaining area of the first memory space 722 may be used as temporary buffer 723 to store pages of extended boot sequence 702a as they are copied to the second memory space 724 and stored as extended boot sequence copy 702b.

Once all pages of extended boot sequence 702a have been copied to the second memory space 724, the CPU 302 reads instructions from the second memory space 724, such as through a RAM interface 307 of FIG. 3. The CPU 302 may be reset to cause it to again fetch instructions from the first address in the second memory space 724.

Instructions from extended boot sequence copy 702b are now read and executed by the CPU 302. These instructions include routines to read complete boot sequence 703a from the next block of flash memory 720, and to write these instructions to the second memory space 724 as complete boot sequence copy 703b. As the last instruction of extended boot sequence copy 702b is executed, the next instruction fetched is from complete boot sequence copy 703b, either fetching sequentially or by a jump or branch.

Complete boot sequence copy 703b is then executed by the CPU 302. The complete boot sequence module 703a is configured to be memory technology specific, for example, SD protocol or block addressable NVM synchronous interface protocol. The memory specific information includes, but is not necessarily limited to, vendor/product/device ID, which can be used for fetching other parameters stored in a pre-installed firmware or database pertinent to the specific memory, for example, timing parameter for reading data and/or commands. The complete boot sequence 703a also includes instructions to read OS image 704a from flash memory 720, and to write it to the second memory space 724 as OS image copy 704b. As the last instruction of the complete boot sequence copy 703b is executed, the next instruction fetched is from the OS image copy 704b, either fetching sequentially or by a jump or branch. After the OS starts, user or application programs may be loaded and executed.

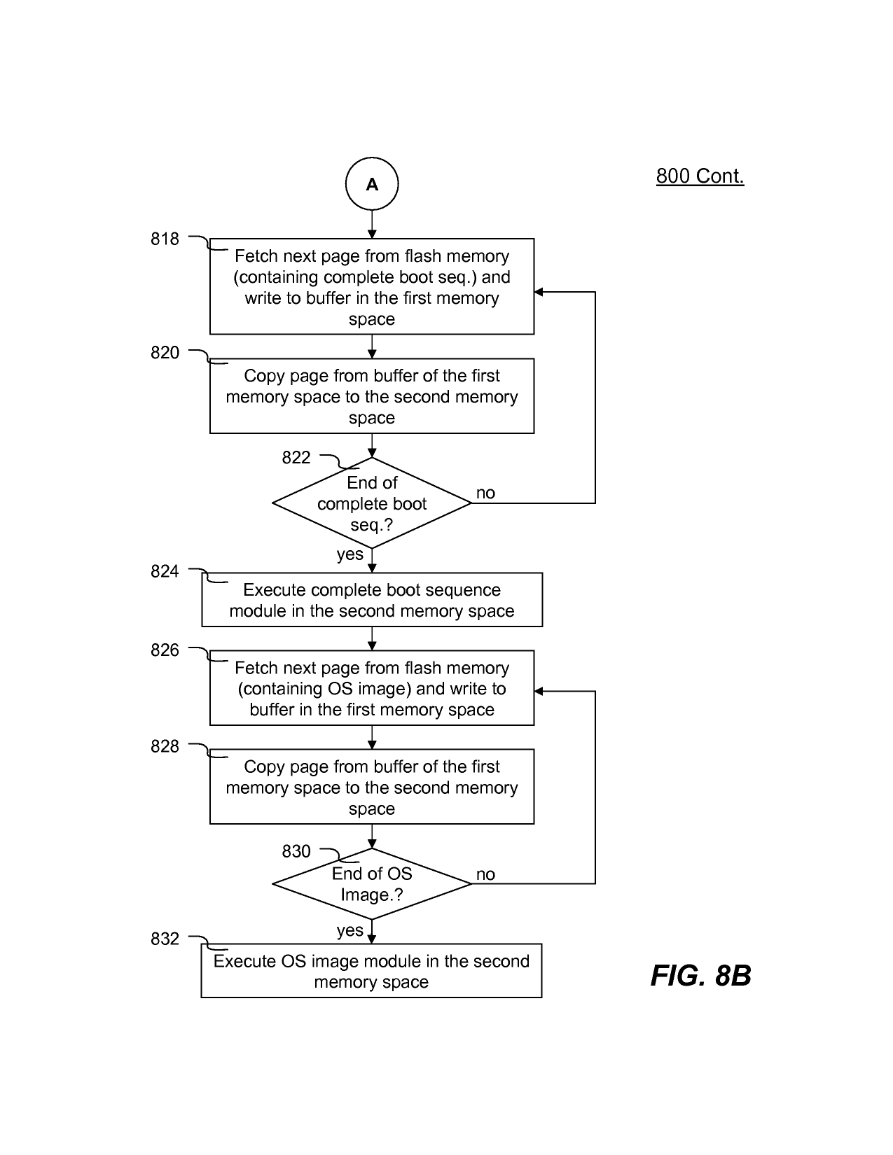

FIGS. 8A-B collectively is a flowchart showing an exemplary process 800 of booting a microcontroller (e.g., SD flash microcontroller 300 of FIG. 3) from multiple memories in accordance with one embodiment of the present invention. The process 800 is preferably understood with previous figures especially FIGS. 3 and 7.

The process 800 starts when the microcontroller receives a power-on or reset. A hardware state machine or other hardwired logic reads the first page of the first block of the flash memory to fetch an initial boot loader module 701a at step 802. Next, at step 804, the process 800 writes the initial boot loader module to a first memory space 722 (e.g., SRAM). The boot loader module is generally small that can be stored in the first page (512-byte) of the first memory space. Then the CPU 302 executes the initial boot loader module at step 806. For example, the CPU 302 is brought out of reset. Instructions contained in the boot loader module is fetched and executed.

In the meantime, extended boot sequence module 702a stored in the next page in the flash memory is read and the next page is written to a buffer area 723 of the first memory space 722 at step 808. The first memory space 722 can be two or more pages in size. The content in the buffer area 723 is copied to a second memory space 724 (e.g., DRAM) at step 810. Next, at decision 812, it is determined whether the extended boot sequence module 702a has been copied from the flash memory. If ‘no’, the process 800 goes back to step 808 until the entire content of the extended boot sequence module has been read. The process 800 follows the ‘yes’ branch to step 814, in which the CPU 302 fetches and executes the extended boot sequence module from the second memory space 724.

During execution of the extended boot sequence module, the complete boot sequence module 703a stored in the next page of the flash memory is written to the buffer 723 at step 818 and then to the second memory space 724 at step 820. Again the process 800 determines whether the end of the complete boot sequence module has been read at decision 822. If ‘no’, the process 800 goes back to step 818 until the decision 822 become ‘yes’. Then the process 800 moves to step 824, in which the CPU 302 executes the complete boot sequence module.

The OS image 704a stored in the next page of the flash memory is written to the buffer 723 at step 826 and then to the second memory space 724 at step 828. Next, at decision 830, it is determined whether the entire OS image 704a has been copied to the second memory space 724. If ‘no’, the process 800 goes back to step 826 until the end of the OS image 704a has been read. Finally, at step 832, the CPU 302 transfers the execution of the complete boot sequence module 703a to the OS image module 704a, such as by a jump instruction contained within the complete boot sequence module 703a. After this point, application and user programs can be loaded and executed by the OS.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a Secure Digital (SD) card interface has been shown and described, other types of connectors such as a Multi Media Card (MMC) interface circuit, a micro Secure Digital (μSD) interface, an embedded SD interface, a Compact Flash (CF) interface circuit, a Memory Stick (MS) interface circuit, a PCI-Express interface circuit, an Integrated Drive Electronics (IDE) interface circuit, a Serial Advanced technology Attachment (SATA) interface circuit, an external SATA interface circuit, a Radio Frequency Identification (RFID) interface circuit, a fiber channel interface circuit, and an optical connection interface circuit may be used to achieve the same function. Additionally, whereas the microcontroller and non-volatile memory have been shown as two separate objects, the microcontroller and the non-volatile memory could be implemented in different forms such as a single chip, single substrate, single chip carrier, single die on a wafer or a single chip scaled package. Furthermore, whereas the size of the data area of a page has been shown to hold four sectors of 512-data, a page holds other number of sectors such as eight may be used. Furthermore, a page size of 512 bytes has been described, other page sizes could be substituted such as 1K, 2K, 4K, etc. Flash blocks may have 4, 8, 16, 32, 64 pages or other number, depending upon the physical flash chips and arrangement used. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of booting a non-volatile memory microcontroller comprising:
activating a state machine on the microcontroller to read an initial boot loader module while the central processing unit (CPU) is in a reset state after detecting a power-on signal, wherein the initial boot loader is located in first page of first block of a non-volatile memory coupled to the microcontroller through a bus;
writing the initial boot loader module to a first memory space in the microcontroller using the state machine;
releasing the CPU from the reset state and executing the initial boot loader module on the CPU by fetching instructions of the initial boot loader module stored in the first memory space;
copying next one or more pages, containing an extended boot sequence module, from the non-volatile memory to a second memory space via a buffer located in the first memory space in response to the instructions of the initial boot loader module;
executing instructions of the extended boot sequence module after the CPU has finished executing all of the instructions of the initial boot loader module;
copying next one or more pages, containing a complete boot sequence module, from the non-volatile memory to the second memory space via the buffer area as the extended boot sequence module is being executed; and
executing instructions of the complete boot sequence module after the CPU has finished executing all of the instructions of the extended boot sequence module.

2. The method of claim 1, further comprising:
copying next one or more pages, containing an operating system (OS) image module, from the non-volatile memory to the second memory space via the buffer area as the complete boot sequence module is being executed; and
executing instructions of the OS image module after the CPU has finished executing all of the instructions of the complete boot sequence module.

3. The method of claim 2, wherein executing instructions of the extended boot sequence module after the CPU has finished executing all of the instructions of the initial boot loader module further comprises writing a control register to change from a first mode to a second mode, wherein the CPU fetches instructions from the first memory space or the second memory space in the first or the second mode, respectively, whereby the control register controls fetching from the first memory space and from the second memory space.

4. The method of claim 3, further comprises:
resetting the CPU after the extended boot sequence has been copied the second memory space; and
reading a first instruction of the instructions of the extended boot sequence module from an initial extended address in the second memory space.

5. The method of claim 4, wherein executing instructions of the complete boot sequence module after the CPU has finished executing all of the instructions of the extended boot sequence module further comprises executing a sequential instruction as a last instruction, wherein the first instruction follows the last instruction sequentially in the second memory space.

6. The method of claim 4, wherein executing instructions of the complete boot sequence module after the CPU has finished executing all of the instructions of the extended boot sequence module further comprises executing a jump instruction as a last instruction, wherein the first instruction separated from the last instruction by intervening instructions in the second memory space.

7. The method of claim 2, wherein the first memory space is a static random access memory with a relatively small capacity, while the second memory space is a dynamic random access memory with a relatively large capacity.

8. A non-volatile memory (NVM) microcontroller comprising:
a NVM bus for connecting to at least one NVM chip, the NVM bus carrying addresses, data and commands to the at least one NVM chip; wherein the at least one NVM chip stores a first group of instructions and a second group of instructions;
an internal bus;
a first memory space, coupling to the internal bus, configured for holding a copy of the first group of instructions for execution;
a second memory space, coupling to the internal bus, configured for holding a copy of the second group of instructions for execution; wherein the first memory space and the second memory space are volatile memories that lose data when power is removed;
a central processing unit (CPU), coupling to the internal bus, configured for accessing and executing the first group of instructions in the first memory space during a first mode and for accessing and executing the second group of instructions in the second memory space during a second mode;
a NVM controller, coupling to the internal bus, configured for generating NVM control signals and configured for buffering commands, addresses, and data to the NVM bus;
an initializer configured for activating the NVM controller to copy the first group of instructions from the at least one NVM chip to the first memory space;
a first module loaded on the CPU and executed by the CPU while in the first mode after the reset signal is de-asserted, the first module contains the first group of instructions stored in the first memory space, wherein the first module activates the NVM controller to copy the second group of instructions from the at least one NVM chip to the second memory space; and
a second module loaded on the CPU and executed by the CPU while in the second mode, the second module contains the second group of instructions stored in the second memory space, wherein the first and second modules are used for booting the NVM microcontroller.

9. The microcontroller of claim 8, further comprises a multiplexer, coupled to both the first memory space and the second memory space, configured for enabling and disabling transfer of instructions.

10. The microcontroller of claim 9, wherein the multiplexer enables transfer of the first group of instructions from the first memory space to the CPU and disables transfer of the second group of instructions in the first mode.

11. The microcontroller of claim 9, wherein the multiplexer enables transfer of the second group of instructions from the second memory space to the CPU and disables transfer of the first group of instructions in the second mode.

12. The microcontroller of claim 8 further comprises a mode register configured for indicating the first and second modes which allow the CPU to execute instructions in respective instructions from respective memory space.

13. The microcontroller of claim 12, further comprising:
a clocked-data interface to a host bus that connects to a host;
a bus transceiver for detecting and processing commands sent over the host bus; and
a data buffer for storing data sent over the host bus.

14. The microcontroller of claim 13, wherein the host bus comprises a Secure Digital (SD) protocol bus.

15. The microcontroller of claim 8, further comprises a direct memory access engine, coupling to the internal bus, configured for transferring data over the internal bus and the NVM bus.

16. The microcontroller of claim 8, wherein the initializer comprises a state machine or a hardware logic and the initializer is activated in response to a power-on or reset signal.

17. The microcontroller of claim 8, wherein the second memory space is accessed through a memory space interface.

18. A multi-interface microcontroller comprising:
flash bus means for connecting to a flash memory, the flash bus means carrying addresses, data, and commands to the flash memory; wherein the flash memory stores an initial boot loader, an extended boot sequence, and a complete boot sequence in non-volatile memory;
first volatile memory means for storing first instructions for execution;
second memory interface means for interfacing to a second volatile memory means for storing second instructions for execution;
processor means for fetching and executing the first instructions in the first volatile memory means during a first mode and fetching and executing the second instructions from the second volatile memory means during a second mode;
flash-memory controller means for generating flash-control signals and for buffering commands, addresses, and data to the flash bus means;
hardwired initializer means, activated by a reset signal, for activating the flash-memory controller means to read the initial boot loader from the flash memory, and for writing the initial boot loader as the first instructions to the first volatile memory means;
initial boot loader execution means for activating the processor means to fetch and execute the first instructions from the first volatile memory means, the initial boot loader execution means for activating the flash-memory controller means to read the extended boot sequence from the flash memory, and for writing the extended boot sequence as the second instructions to the second volatile memory means; and
extended boot sequence execution means for activating the processor means to fetch and execute the second instructions from the second volatile memory means, the extended boot sequence execution means for activating the flash-memory controller means to read the complete boot sequence from the flash memory, and for writing the complete boot sequence as additional second instructions to the second volatile memory means.

19. The multi-interface microcontroller of claim 16 further comprises transfer means for transferring execution by the processor means form the first volatile memory means to the second volatile memory means,

20. The multi-interface microcontroller of claim 19, wherein the transfer means further comprises:
control register means for indicating the first mode and the second mode. wherein the processor means fetches instructions from the first volatile memory means during the first mode and fetches instructions from the second volatile memory means during the second mode; and
toggle means, activated by the initial boot loader execution means, for changing the control register means from the first mode to the second mode before the extended boot sequence execution means is activated.
